(19) United States
(12) Patent Application Publication
(10) Pub. No.: US 2026/0340668 A1
(43) Pub. Date: Oct. 29, 2026

(54) CRITIQUING ITEM LISTINGS USING BUYER PERSPECTIVES GENERATED BY ARTIFICIAL INTELLIGENCE LEVERAGING KNOWLEDGE GRAPHS

(71) Applicant: eBay Inc., San Jose, CA (US)

(72) Inventor: Shrivatsan Navalpakkam Rajagopalan, San Jose, CA (US)

(73) Assignee: eBay Inc., San Jose, CA (US)

(21) Appl. No.: 19/192,759

(22) Filed: Apr. 29, 2025

(51) Int. Cl. G06Q 30/0203; G06Q 30/0204

(52) U.S. Cl. CPC G06Q 30/0203; G06Q 30/0204

(57) ABSTRACT

Various aspects of the present disclosure relate to critiquing item listings using buyer perspectives generated by artificial intelligence (AI) leveraging knowledge graphs. A listing critique tool segments users of an online marketplace into a set of segments based on data maintained by the online marketplace about the users. The listing critique tool fine-tunes multiple generative AI models using the data, where each generative AI model is fine-tuned using the data of a respective segment of the set of segments to cause the generative AI model to emulate the users within the respective segment. The listing critique tool generates a prompt configured to elicit critiques of an item listing from the multiple fine-tuned generative AI models by incorporating information extracted from the item listing into the prompt. The listing critique tool generates a modification to the item listing based on the critiques from the multiple fine-tuned generative AI models.

### BACKGROUND

To generate an item listing on an online marketplace, a user inputs information regarding the item (e.g., a title of the item, a description of the item, etc.) into a user interface associated with an online marketplace. However, in some cases, the user has little to no knowledge of how to make the item listing attractive to potential buyers of the online marketplace, e.g., because the user is a non-native speaker of a language in which the online marketplace is published. As a result, the item listing generated based on the user input can be unattractive to potential buyer causing the potential buyers to bypass the item listing or report the item listing as fraud.

### SUMMARY

Techniques for critiquing item listings using buyer perspectives generated by artificial intelligence (AI) leveraging knowledge graphs are described. In some examples, the techniques described herein include segmenting users of an online marketplace into a set of segments based on data maintained by the online marketplace about the users. Techniques further include fine-tuning multiple generative AI models using the data. In some examples, each generative AI model is fine-tuned using the data of a respective segment of the set of segments to cause the generative AI model to emulate the users within the respective segment. The techniques further include generating a prompt configured to elicit critiques of an item listing from the multiple fine-tuned generative AI models by incorporating information extracted from the item listing into the prompt. The techniques further include generating a modification to the item listing based on the critiques from the multiple fine-tuned generative AI models.

The Summary introduces a selection of concepts in a simplified form. Further aspects are described in the Detailed Description. The Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the below accompanying FIGS. Entities represented in the FIGS. are indicative of one or more entities and thus reference is made interchangeably to single or plural forms of the entities in the discussion.

FIG. 1 illustrates an example of an environment that supports critiquing item listings using buyer perspectives generated by AI leveraging knowledge graphs.

FIG. 2 illustrates an example of a flow that supports critiquing item listings using buyer perspectives generated by AI leveraging knowledge graphs.

FIG. 3 illustrates an example of a component diagram that supports critiquing item listings using buyer perspectives generated by AI leveraging knowledge graphs.

FIG. 4 illustrates an example of a procedure that supports critiquing item listings using buyer perspectives generated by A leveraging knowledge graphs I.

FIG. 5 illustrates an example of a system that supports critiquing item listings using buyer perspectives generated by AI leveraging knowledge graphs.

### DETAILED DESCRIPTION

### Overview

In some examples, a user utilizes an online marketplace to sell an item. To sell the item on the online marketplace, the user inputs information regarding the item to generate an item listing. For example, the user inputs one or more of a title of the item, a short description of the item, a condition of the item, a visual representation of the item, etc. to generate the item listing. However, in some examples, the user is unaware of what information regarding the item is relevant or irrelevant to potential buyers. As a result, the user can unintentionally generate item listings that are not attractive to the potential buyers. That is, potential buyers bypass the item listings even if the item listing suits the potential buyers'wants or needs.

As described herein, a device (e.g., a processor) integrated with the online marketplace generates critiques of item listings of the online marketplace using AI generated buyer perspectives. In some examples, the device segments users of the online marketplace into a set of segments based on information maintained by the online marketplace regarding the users, where each segment represents a respective demographic of users. In some examples, the information maintained by the online marketplace includes an age of the users, a gender of the users, an education of the users, buying habits of the users, etc. Further, the device fine-tunes multiple generative AI models using the information maintained by the online marketplace. In some examples, the device fine-tunes a generative AI model using the information of a particular segment of the set of segments such that the fine-tuned generative AI model emulates users within the segment.

Further, the device generates a prompt to elicit critiques of an item listing from the multiple fine-tuned generative AI models by incorporating information extracted from the item listing into the prompt. In some examples, the information extracted from the item listing includes a title of an item, a short description of the item, a condition of the item, a visual representation of the item, etc. In one implementation, a critique of the item listing indicates which parts of the item listing are irrelevant vs. relevant from a perspective of users of a particular segment. Using the critiques, the device generates at least one modification to the item listing and in some cases, displays the at least one modification to a user (e.g., a seller). For example, the device generates a modification to the title of the item included in the item listing.

The techniques as described herein provide a seller of the online marketplace meaningful insight on item listings from multiple buyer's perspectives. This allows the seller to modify item listings based on the insight which results in item listings that are more attractive to potential buyers.

Using other techniques, the seller of the online marketplace can update their item listing based on feedback provided by buyers of the online marketplace. However, buyers may not have the time to provide this feedback to the seller. Additionally, the feedback provided by the buyers may not be accurate or helpful to the seller. Using the techniques as described herein, critiques of items listings are provided automatically to the seller, not only based on buyer feedback, but other information maintained by the online marketplace which increases the accuracy of the critiques. Further, generative AI models are trained to generate critiques from multiple buyers'perspectives which gives the seller insight into how different buyers or groups of buyers view their item listing which enables the seller to modify their listing such that the item listing is attractive to a particular buyer or group of buyers.

### Example Environment

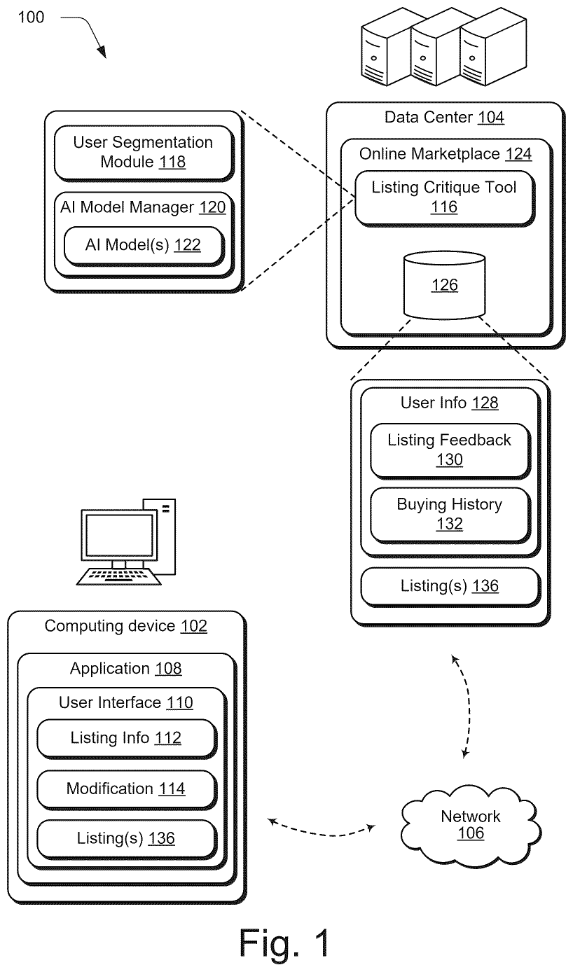

FIG. 1 illustrates an example of an environment 100 that supports critiquing item listings using buyer perspectives generated by AI leveraging knowledge graphs as described herein. In some examples, the environment 100 includes a computing device 102 and a data center 104. As shown in FIG. 1, the computing device 102 and the data center 104 are communicatively coupled to one another via a network 106. The network 106 is configurable in a variety of ways, an example of which is the Internet.

Although the data center 104 is depicted in the environment 100 separate from the computing device 102, in one or more implementations, an entirety or various portions of the data center 104 are implemented at or by the computing device 102. For instance, a portion of the data center 104 is implemented by an application 108 of the computing device 102 and/or using various resources of the computing device 102, such as hardware resources, an operating system, firmware, and so forth.

The computing device 102 is configured in a variety of ways. For example, the computing device 102 is configured as a desktop computer, a laptop computer, a mobile device, an IoT device, a wearable device (e.g., a smart watch, a ring, or smart glasses), an AR/VR device (e.g., the smart glasses), a server, etc. As such, the computing device 102 ranges from a full resource device with substantial memory and memory resources to a low-resource device with limited memory and processing resources. Although the computing device 102 is illustrated as a singular device, it is understood that the computing device 102 is also representative of multiple of different devices, e.g., multiple servers of a server farm.

In at least one implementation, the application 108 supports communication of data across the network 106, such as between the computing device 102 and the data center 104. By supporting such data communication, the application 108 provides a respective user of the computing device 102 (and users of other computing devices) access to an online marketplace 124 of the data center 104. One example of the application 108 is a browser or other web-based application that facilitates user interaction with one or more features of the online marketplace 124. Another example of the application 108 is a web-based computer application, such as a mobile application or desktop application, that facilitates user interaction with one or more features of the online marketplace 124. The application 108 is configured in different ways, which enables the user to interact with the computing device 102 and by extension perform actions to interact with the features of the online marketplace 124, without departing from the spirit or scope of the techniques described herein.

For instance, the application 108 interfaces with databases, user interfaces, and other software systems to receive inputs and deliver outputs. For instance, a user interface 110 displayed via the computing device 102 includes or is an example of a user interface of the online marketplace 124. Through interaction of a user with the user interface 110, the application 108 receives user input via the computing device 102. Examples of such input include, but are not limited to, receiving touch input in relation to portions of a displayed user interface, receiving one or more voice commands or other audio input, receiving typed input (e.g., via a physical or virtual (“soft”) keyboard), receiving mouse or stylus input, and so forth. Based on the received user input, the application 108 causes various systems of the computing device 102 to output information associated with the online marketplace 124 via the user interface 110. For instance, the computing device 102 can display the user interface 110 via display devices or by making accessible voice-based user interfaces.

In some examples, the user interface 110 includes or is an example of a GUI associated with the application 108 and/or the online marketplace 124. A user inputs information via interactable elements of the GUI (e.g., fill in a text element, elect a selectable element, or the like). For instance, the user inputs a search term (e.g., one or more keywords) into a search function of the application 108 to search for items listed for sale on the online marketplace 124. The application 108 returns a list of search results based on the search term, where the list of search results includes one or more listings 136 of the online marketplace 124. The user clicks on (i.e., select) a listing 136 to view the item and information associated with the listing 136, such as a price, a category, related items, or the like, and purchases the item.

Broadly speaking, the online marketplace 124 is configured to generate listings 136 for items and to expose those listings 136 (e.g., publish them) across the network 106 to one or more computing devices, including to the computing device 102. For instance, the online marketplace 124 generates listings 136 for items for sale and expose those listings 136 to computing devices, such that users of the computing devices can interact with the listings 136 via user interfaces to initiate transactions (e.g., purchases, add to wish lists, share, and so on) in relation to the respective item or items of the listings 136. The online marketplace 124 is configured to generate listings 136 for one or more types of physical goods or property (e.g., clothing and/or clothing accessories, collectibles, furniture, decorative items, textiles, luxury items, electronics, real property, physical computer-readable storage having one or more video games or other digital content stored thereon, and so on), services (e.g., babysitting, dog walking, house cleaning, home repair, general contracting, and so on), digital items (e.g., digital images, digital music, digital videos) that can be downloaded via the network 106, and blockchain backed assets (e.g., non-fungible tokens (NFTs)), to name just a few.

In the illustrated environment 100, the online marketplace 124 includes a storage device 126, which maintains real-time listing data for listings 136 of the online marketplace 124. The storage device 126 represents one or more databases and/or other types of storage capable of storing the real-time listing data. Additionally, the storage device 126 of the online marketplace 124 stores user data, which includes information related to users of the online marketplace 124. Examples of user data include, but are not limited to, purchase history and transaction data related to purchases of users (e.g., based on a user identifier from a user account, including a username of the account or other identifier), user engagement and behavior data (e.g., information about user interactions with the listings 136 and the online marketplace 124), information input by the user, information inferred about the user based on other aspects of the user data, and so forth. For instance, a user purchases a television listed on the online marketplace 124, and the storage device 126 stores, as user data, transaction data indicating that the user (e.g., with an associated user account and/or user identifier) purchased the television, a price for which the television was purchased, time and date information of the transaction, and the like. The storage device 126 can store information input by the user (e.g., at a local database) for access upon request by the data center 104. Additionally, or alternatively, the computing device 102 transmits the information input by the user via the network 106 for storage at the storage device 126.

Examples of the storage device 126 include, but are not limited to, mass storage and virtual storage. In one or more implementations, for instance, the storage device 126 is virtualized across a plurality of data centers and/or cloud-based storage devices. The online marketplace 124 is implemented using servers that execute stored instructions to deploy various services of the online marketplace 124, such that those services perform numerous computations which are effective to provide the functionality described above and below. It is to be appreciated that the online marketplace 124 includes more, fewer, or different components without departing from the spirit or scope described herein.

Users that cause items to be listed on the online marketplace 124 are referred to as “sellers,” whereas users that purchase or otherwise obtain items listed on the online marketplace 124 via the listings 136 are referred to as “buyers.” Sellers and buyers both interact with user interfaces of the online marketplace 124 (e.g., via the application 108) to perform the desired functionality. In addition, an individual user of the online marketplace 124 can interact via the interfaces to be both a seller and a buyer on the online marketplace 124, such as by interacting with the user interfaces to create a listing 136 on the online marketplace 124 and by interacting with the user interfaces to purchase one or more items from the listings 136 of the online marketplace 124.

A user that is a seller, for instance, interacts with one or more user interfaces of the online marketplace 124 (e.g., output via the application 108, such as the user interface 110) to provide information about one or more items which the user is causing to be listed on the online marketplace 124. Such user interfaces include prompts that instruct, or guide, users that are sellers to provide various information about items being listed. Examples of information that such interfaces prompt sellers for and that those users provide include but are not limited a title, description (of the item), one or more prices (e.g., to purchase the item now and/or a minimum starting bid for the item), brand information, size, year, color(s), shipping information (e.g., cost and/or types available), delivery information, return information, payment information, images, videos, models, authenticity information, item history (e.g., chain of custody), and condition (of the item), to name a few.

One or more portions of such information are referred to herein as “attributes” of a listing 136. For instance, a title of the listing 136 is an attribute of the listing 136, a description of the item being listed is an attribute of the listing 136, one or more images uploaded or selected for the listing 136 are one or more attributes of the listing 136, color(s) of the item is an attribute of the listing 136, a category of the item is an attribute of the listing 136, and so forth.

In one or more implementations, the online marketplace 124 saves and maintains the input information for a listing 136 in the storage device 126 in fields of a data structure or data record populated for the listing 136, where a given field and the information populated and maintained for the given field correspond to a particular attribute of the listing 136. For instance, a ‘title’ field of such a data structure or data record is populated with information (e.g., text) input into a user interface by a seller of a listing 136. The title field and the information input by the user as the title of the listing 136 correspond to an attribute of the listing 136, e.g., a title attribute. In one or more implementations, one or more of the attributes of a listing 136 are derived and then populated by the online marketplace 124, such as by the online marketplace 124 processing one or more portions of the information input by a user to populate one or more respective attributes of the listing 136.

In addition to any one or more of those attributes, each of the listings 136 of the online marketplace 124 is also associated with a ‘category’ attribute—at least one category attribute. As used herein, the term “category” refers a grouping of related items on the online marketplace 124. The use of categories is designed to help users (e.g., buyers) easily navigate and find items that share similar attributes or purposes. Categories are typically organized in a hierarchy, allowing users to explore broad item types (e.g., “Electronics”) and then drill down into more specific subcategories (e.g., “Mobile Phones,” “Laptops,” etc.). By organizing items into categories, the online marketplace 124 enhances user experience, simplifies search, and improves the efficiency of browsing and filtering options.

In one or more implementations, user interfaces, such as the user interface 110, that are presented to a seller as part of collecting information for generating a listing 136 include one or more interactive elements which enable the user to provide a category for an item being listed, e.g., a hierarchy of the categories for selection, a dropdown of categories, a field (e.g., a text field) for typing categories, or for beginning to type categories which are then suggested as selectable tags, to name a few. Thus, user input attributes for a listing 136 include a user input, or otherwise selected, category for the listing 136. As discussed above and below, the user-input category is used, along with other information (e.g., other attributes of the listing 136), as a basis (or one piece of information) for assigning a category to the listing 136.

In variations, the computing device 102 collects user input and provide information to a user via the user interface 110. The computing device 102 can receive user input via the user interface 110 that causes the computing device 102 to execute instructions, such as to cause the computing device 102 to transmit or receive data to and from the data center 104 (e.g., via the network 106). The computing device 102 configures the user interface 110 to display, or otherwise present, controls that are selectable by a user to provide the user input and/or prompts requesting user input. For instance, the computing device 102 can receive the user input via one or more input components of the user interface 110. The user input is in response to a request for user input from the computing device 102 and/or is initiated by a user of the computing device 102. Based on receiving the user input via the user interface 110, the computing device 102 transmits data to the data center 104.

As shown in FIG. 1, the online marketplace 124 includes a listing critique tool 116. The listing critique tool 116 of the online marketplace 124 is configured to generate one or more modifications 114 (or one or more recommendations) to a listing 136 of the online marketplace 124. To generate the one or more modifications to the listing 136, the listing critique tool 116 employs at least a user segmentation module 118 and an AI model manager 120.

The user segmentation module 118 is operable to segment users of the online marketplace 124 into multiple segments based on data maintained by the online marketplace 124. In one or more implementations, the data maintained by the online marketplace 124 includes any of the data stored by the storage device 126. In some implementations, the data maintained by the online marketplace 124 includes user information 128. User information 128 includes one or more of a buying history 132 of users, listing feedback 130 of users, search query history of users, ages of users, economic statuses of users, genders of users, educations of users, etc. In some examples, the listing feedback 130 of users includes comments generated by users regarding listings 136 of the online marketplace 124. For instance, the listing feedback 130 of users includes comments indicating whether the users'received items that were accurately described by the listings 136 or any other feedback regarding the listings 136. In some implementations, the data center 104 also maintains data obtained from third-party vendors. For example, the data center 104 maintains data obtained from a third-party search engine.

In some implementations, each segment of the multiple segments is representative of a different demographic of users or a different buyer persona. In one implementation, a segment represents a specific age demographic of users such as users of an age range 18-25 years of age. In another implementation, a segment represents specific economic demographic of users such as users of a middle-class income. In yet another implementation, a segment represents a more granular demographic of users. For example, the segment represents users of an age range 18-25 years of age and of a middle-class income. Other segmentation strategies are possible. The techniques as described herein are not limited to the example segmentation strategies.

The AI model manager 120 of the listing critique tool 116 is operable to train and fine-tune one or more AI models 122. In one or more implementations the one or more AI models 122 are examples of generative AI models. In some implementations, the AI model manager 120 trains the one or more AI models 122 to output critiques for listings 136 of the online marketplace 124. In one or more implementations, the critiques indicate irrelevant vs. relevant portions of the listings 136 from a perspective of buyers of the online marketplace 124. For instance, an AI model 122 generates a critique for a particular listing 136 that indicates that an item detailed description is relevant because the item detailed description provides buyers with necessary information about the product. In one or more implementations, the AI model manager 120 trains the one or more AI models 122 using the data maintained by the online marketplace 124. For example, the AI model manager 120 trains the one or more AI models 122 using listings 136 (e.g., old listing or current listings), listing feedback 130 of the users regarding the listings 136, buying history 132 of the users, or other data maintained by the online marketplace 124 (e.g., a knowledge graph that includes buyer discovery, seller listings, buyer browsing, buyer shopping, buyer searching, buyer decisions, buyer payments, seller payouts, seller shipments, seller invoices, seller shipping labels, or seller returns).

The AI model manager 120 further fine-tunes the one or more AI models 122 to generate critiques for particular segments of users. In some implementations, the AI model manager 120 fine-tunes an AI model 122 for each respective segment of users as determined by the user segmentation module 118. To fine-tune a respective AI model 122, the AI model manager 120 updates one or more parameters of the AI model 122 using data maintained by the online marketplace 124 that corresponds to the respective segment of the AI model 122. In other words, the AI model manager 120 fine-tunes the AI model 122 such that the fine-tuned AI model 122 develops a buyer's perspective similar to that of the corresponding segment of users. A buyer's perspective of an item listing refers to an interpretation of the item listing from a perspective of a buyer of the online marketplace. In other words, the buyer's perspective is how the buyer of the online marketplace interprets the item listing. Buyers that belong to the same segment have similar buyer's perspectives, whereas buyers that belong to different segments have different buyer's perspectives. As an example, a buyer's perspective from a first segment of buyers deems a detailed description of an item's condition useful when making a decision to purchase an item, whereas a buyer's perspective from a second segment deems the detailed description of the item's condition unhelpful when making a decision to purchase the item. Thus, in some implementations, each AI model 122 of the one or more AI models 122 generates a different or same critique for a same listing 136 relative to one another.

During operation, the listing critique tool 116 obtains listing information 112 regarding a listing 136 of the online marketplace 124. In some implementations, the listing 136 is published to (or active on) the online marketplace 124. In such implementation, the listing critique tool 116 extracts the listing information 112 from the published listing 136. In another implementation, the listing 136 is not yet been published to (or is not active on) the online marketplace 124. In such implementation, the listing critique tool 116 obtains the listing information 112 from the computing device 102. That is, the user inputs the listing information 112 via the user interface 110 of the application 108. In some implementations, the listing information 112 includes an image of an item, a video of the item, audio associated with the item, or a text attribute of the item (e.g., a title of the item, a detailed description of the item, or a condition of the item).

The listing critique tool 116 then analyzes the listing information 112 and generates a prompt for the one or more fine-tuned AI models 122 by incorporating at least some of the listing information 112 into the prompt. The prompt is configured to elicit critiques of the listing 136 from the one or more fine-tuned AI models 122. The prompt acts as a guide providing context for the one or more fine-tuned AI models 122. For example, the prompt states “Generate a critique for an item listing that includes the title ‘Apple Watch Ultra 2, Titanium Case, CONDITION: New’.” The listing critique tool 116 then inputs the prompt into the fine-tuned AI models 122 and each of the one or more AI models outputs a respective critique of the listing 136. In some implementations, the critique output by a respective AI model 122 is a buyer's reflection of the listing 136 from the perspective of users of a segment used to fine-tune the respective AI model 122. Below is an example of a critique output from an AI model 122 of the one or more AI models 122:
Relevant information: These details provide essential information about the product's features and specification, helping the buyer understand its capabilities and compatibility.
**ITEM_DESC: ** null
Relevant information: There is no item description provided, which could be seen as irrelevant since the buyer is not given any additional information about the product's condition, usage, or any other specifics.
Based on this analysis, the following contradictions can be identified:
1. **Item Description: ** The absence of an item description can be seen as irrelevant since the buyer is not given any additional information about the product's condition, usage, or any other specifics.
2. **Item Aspects and Item Aspects: ** While the item aspects (brand, color, connectivity, model, sensors, storage capacity, and type) are relevant, the lack of a detailed item description can leave the buyer with questions or uncertainties about the product's condition or usage.
3.**Item Condition and Item Aspects: ** The provided item condition (used) is irrelevant since it informs the buyer about the product's condition. However, the absence of a detailed item description leads to lack of clarity on the product's condition, usage, or any other specifics.
In conclusion, the provided information is mostly relevant, with the notable exception of the absence of a detailed item description. This omission can lead to uncertainties or unanswered questions for the buyer. To improve the listing, the seller should consider adding a detailed item description to provide the buyer with all necessary information about the product's condition, usage, and other specifics.

In some implementations, prior to generating the critiques, the listing critique tool 116 receives user input identifying which of the segments that the user requests critiques from. In one or more implementations, the user inputs the requested segments in the computing device using the user interface 110 of the application 108. In response to the user input, the listing critique tool 116 generates critiques for the requested segments.

In some implementations, upon generating the critiques, the listing critique tool 116 synthesizes the critiques generated by the one or more AI models 122 and generates one or more modifications 114 to the listing 136. In one or more implementations, the one or more modifications 114 includes a modification to an item title, a modification to a condition of the item, a modification to a text description of the item, a modification to a visual representation of the item, etc.

In some implementation, the listing critique tool 116 provides the one or more modifications 114 to the user. For example, the application 108 displays the one or more modifications 114 to the user via the user interface 110 of the application 108. In one implementation, when the one or more modifications 114 to the listing 136 are available, a notification (e.g., a push notification) is displayed to the user via the user interface 110 of the application 108. Upon selecting the notification, the user interface 110 of the application 108 displays the listing 136 for which the one or more modifications 114 are ready. In some implementations, the one or more modifications 114 appear as colored text (e.g., red text or green text) adjacent to (e.g., directly below or above) a corresponding section of the listing 136. For example, a modification to the title appears adjacent to the title of the listing 136. In some implementation, the application 108 allows the user to: 1) accept the one or more modifications 114 to the listing 136, 2) edit the listing 136 based on the one or more modifications 114, or 3) maintain the listing 136 in its original form. In some implementations, the colored text identifying the one or more modifications 114 is selectable. Upon selecting the colored text, a reasoning for the modification is displayed to the user. Using the techniques as described herein, a seller of an online marketplace 124 receives meaningful buyer insight into their listings 136 which allows the seller to make the listings 136 more marketable on the online marketplace 124.

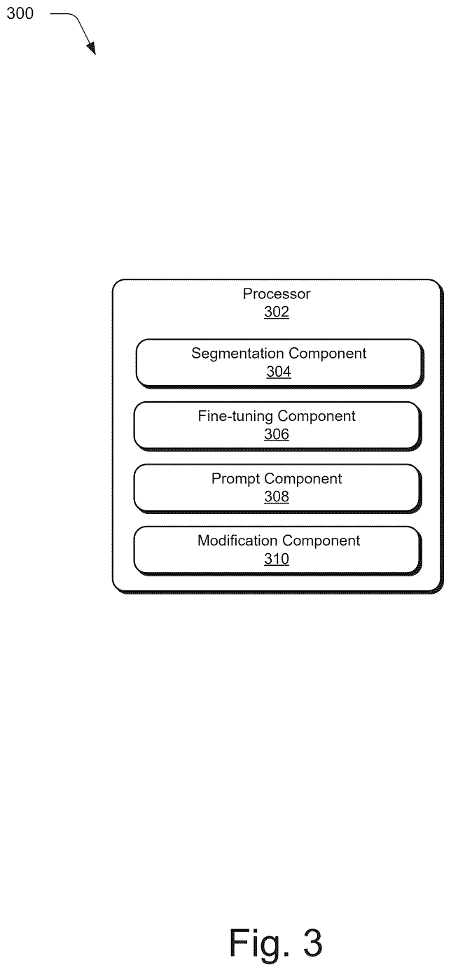

As used herein, the term “AI model” refers to a computer representation that is tunable (e.g., through training and retraining) based on inputs, without being actively programmed by a user, to approximate unknown functions, automatically and without user intervention. The AI models 122 includes or is an example of one or more computational algorithms or systems designed to process input data, recognize patterns, and make predictions or decisions without being explicitly programmed for a specific task. The AI models 122 execute on one or more processors, such as one or more processors described with reference to FIG. 3, and can “learn” by iteratively analyzing training data and generating outputs that reflect patterns and attributes of the training data. In some implementations, two or more AI model(s) 122 can be implemented as a single AI model.

The AI models 122 can implement or include various types of AI models, such as neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc. for performing the techniques described herein. Examples of the AI models 122 can include, but are not limited to, LLMs, multimodal models, and generative AI models.

A generative AI model is an AI model designed to generate an output using one or more input conditions or labels. Unlike conventional AI systems that rely on rule-based or deterministic approaches, generative AI employs algorithms and models capable of autonomously producing output that closely resembles human-generated content. These algorithms are designed to learn patterns and structures from existing data and then use this learned information to generate new content that is coherent, relevant, and contextually appropriate. In some implementations, the generative AI model leverages knowledge graphs. A knowledge graph refers to a structured representation of information that captures relationships between various terms (e.g., concepts or entities) relevant to performing a task (e.g., a task performed by the generative AI model in response to a prompt). The knowledge graph includes nodes (e.g., parent node and child nodes) and edges connecting the nodes. Each term is represented by a node and the edges define the relationships between the terms. In sum, the structure of a knowledge graph provides an efficient organization, traversal, and retrieval of information relevant to the task. For example, in operation, the generative AI model traverses the knowledge graph, utilizes relationships defined within the knowledge graph to obtain relevant information, and utilizes the relevant information to generate a response to the prompt (e.g., generate the modification 114).

### Example Flow

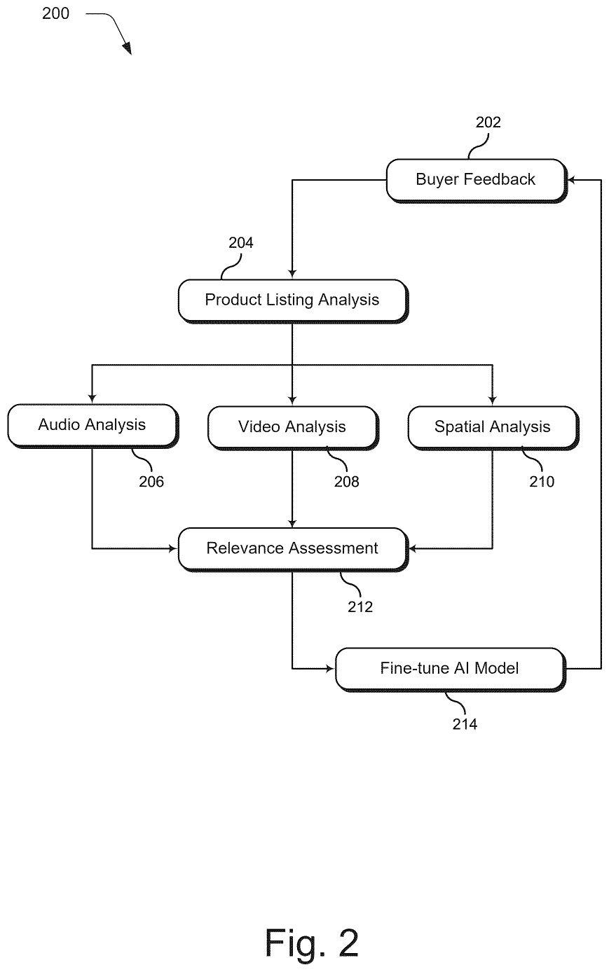

FIG. 2 illustrates a flow 200 that supports critiquing item listings using buyer perspectives generated by AI leveraging knowledge graphs as described herein. In some examples, the flow 200 is implemented by aspects of the environment 100. For example, the flow 200 is implemented by the listing critique tool 116 as described with reference to FIG. 1.

As described with reference to FIG. 1, the listing critique tool 116 of an online marketplace segments users (or buyers) of the online marketplace into multiple segments using data maintained by the online marketplace such that each segment represents a different demographic of users. Upon segmenting the users, the listing critique tool 116 fine-tunes multiple AI generative models to generate critiques of item listings of the online marketplace based on the data maintained by the online marketplace and information obtained from item listings of the online marketplace. Specifically, the listing critique tool 116 fine-tunes each generative AI model to generate a critique of an item listing that emulates users of a respective segment.

The following outlines a procedure for fine-tuning an AI model of the multiple AI models.

At 202, the listing critique tool 116 obtains feedback from users within a segment regarding one or more item listings of the online marketplace. In some implementations, the feedback includes positive or negative criticism regarding aspects of the one or more item listings of the online marketplace. For example, some of the users within the segment indicate, via the feedback, that audio data included in a respective item listing of the online marketplace was not considered helpful to the user when making a decision to purchase an item of the respective item listing. As another example, the feedback includes improvements to aspects of the one or more item listings. For example, some of the users within the segment indicate, via the feedback, that adding an image of an item of a respective item listing from a different angle would be helpful when making a decision to purchase the item.

At 204, the listing critique tool 116 analyzes (or synthesizes) item listings of the online marketplace. In some implementations, analyzing the item listings include analyzing audio data, video data, image data, spatial data, or text attributes (e.g., a title of the item, a detailed description of the item, etc.) of the item listings. More specifically, in some implementations, the listing critique tool 116 evaluates speech content and noise of the audio data at 206. As an example, the listing critique tool 116 analyzes video(s) included in the item listing for a presence or absence of noise.

Additionally, or alternatively, the listing critique tool 116 evaluates critical frames and emotion of the video data at 208. As an example, the listing critique tool 116 analyzes keywords of the listing and searches for a link between the keywords of the listing and an emotional state. In another implementation, the listing critique tool 116 analyzes auditory signals of the video data of the item listing and uses automatic-speech-recognition technology trained on data, such as customer support voice recordings, to sense an emotional state. In some implementations, the listing critique tool 116 elicits the critical frames of the video data based on a duration of a video of the item listing having near-similar or similar visual content or auditory signals which indicates a thematic weight to a concept or entity in the video data. In some examples, the listing critique tool 116 analyzes the critical frames using one or more pre-trained models, e.g., pre-trained models that are GPU or CPU optimized to be highly accurate at extracting critical frames.

Additionally, or alternatively, the listing critique tool 116 evaluates 3D space of the spatial data at 210. For example, the listing critique tool 116 extracts the spatial data using “point cloud” information which is encoded in the video data of the item listing. Additionally, or alternatively, the listing critique tool 116 utilizes existing codecs to extract spatial data via visual reasoning with or without “point cloud” information. Further, in some examples, the listing critique tool 116 interlaces the spatial data with the emotion data to associate emotional states with spatial details from the video data of the item listing.

In some examples, as a result of the analysis, the device determines that at least some of the item listings include audio data. For example, the device obtains a first set of audio data corresponding to a first item listing (e.g., input by a first user) and second set of audio data corresponding to a second item listing (e.g., input by a second user). In another implementation, the device determines that at least some of the item listings include video data. In such implementation, the device obtains a respective set of video data for each of the item listings and determines a respective emotion expressed within each set of video data.

At 212, the listing critique tool 116 performs a relevance assessment. As part of the relevance assessment, the listing critique tool 116 makes a determination of whether the item listings include irrelevant information based on the analysis and the feedback provided by the users. For example, if the feedback provided by the users indicates that the presence of noise in videos is irrelevant and the listing critique tool 116 identifies a presence of noise in a video of the item listing, the listing critique tool 116 flags the audio data included in the item listing as irrelevant. In some examples, the listing critique tool 116 converts the audio data to another format (e.g., text) for flagging. In one implementation, if the feedback provided by the users indicates that detailed descriptions of items that lack description of the item's condition or usage are irrelevant and the detailed description of the item listing omits the item's condition or usage, the listing critique tool 116 flags the detailed description of the item listing as irrelevant. In another implementation, the listing critique tool 116 flags a portion of the detailed description of the item listing as irreverent because the portion of the detailed description is inconsistent with another portion of the detailed description or describes a different item. As another example, the listing critique tool 116 flags a portion of video data included in the item listing as irrelevant because the portion of the video data does not display the item.

At 214, the listing critique tool 116 fine-tunes the generative AI models based on the relevance assessment. For example, the listing critique tool 116 fine-tunes the generative AI model corresponding to the segment to generate critiques for item listings that are consistent with the relevance assessment performed at 212.

### Example Device

FIG. 3 illustrates an example of a component diagram 300 of a processor 302 that supports critiquing item listings using buyer perspectives generated by AI leveraging knowledge graphs as described herein. In some implementations, the processor 302 is an example of a listing critique tool 116 as described with reference to FIG. 1. The processor 302, or various components thereof, is an example of means for performing various aspects of critiquing item listings using buyer perspectives generated by AI leveraging knowledge graphs described herein. For example, the processor 302 includes a segmentation component 304, a fine-tuning component 306, a prompt component 308, and a modification component 310. Each of these components communicate, directly or indirectly, with one another.

The segmentation component 304, the fine-tuning component 306, the prompt component 308, and the modification component 310 are implemented in code (e.g., as software or firmware) executed by the processor 302. If implemented in code executed by the processor 302, the functions of the segmentation component 304, the fine-tuning component 306, the prompt component 308, and the modification component 310 are performed by a general-purpose processor, a digital signal processor (DSP), a central processing unit (CPU), an ASIC, an FPGA, a microcontroller, or any combination thereof.

The segmentation component 304 is capable of, configured to, or operable to support a means for segmenting users of an online marketplace into a set of segments based on data maintained by the online marketplace about the users. The fine-tuning component 306 is capable of, configured to, or operable to support a means for fine-tuning multiple generative AI models using the data, where each generative AI model is fine-tuned using the data of a respective segment of the set of segments to cause the generative AI model to emulate the users within the respective segment. The prompt component 308 is capable of, configured to, or operable to support a means for generating a prompt configured to elicit critiques of an item listing from the multiple fine-tuned generative AI models by incorporating information extracted from the item listing into the prompt. The modification component 310 is capable of, configured to, or operable to support a means for generating a modification to the item listing based on the critiques from the multiple fine-tuned generative AI models.

The modification component 310 is further capable of, configured to, or operable to support a means for receiving user input requesting feedback about the item listing from a perspective of users within at least one segment of the set of segments. The modification component 310 is further capable of, configured to, or operable to support a means for generating multiple modifications to the item listing based on the user input, each modification corresponding to a respective at least one segment.

The fine-tuning component 306 is further capable of, configured to, or operable to support a means for receiving audio data, associated with a particular item listing, from each of the users, the audio data including a first set of audio data for a first user and a second set of audio data for a second user, analyzing the first set of audio data and flagging a first portion of the first set of audio data that is irrelevant to the particular item listing, analyzing the second set of audio data and flagging a second portion of the second set of audio data that is irrelevant to the particular item listing, and fine-tuning the multiple generative AI models based on analyzing the first portion of the first set of audio data flagged and the second portion of the second set of audio data flagged.

The fine-tuning component 306 is further capable of, configured to, or operable to support a means for receiving video data, associated with a particular item listing, from each of the users, the video data including a first set of video data for the first user and a second set of video data for the second user, determining a first emotion expressed within the first set of video data, determining a second emotion expressed within the second set of video data, and fine-tuning the multiple generative AI models based on determining the first emotion and the second emotion.

In some examples, the fine-tuning component 306 is further capable of, configured to, or operable to train a first generative AI model on flagged item listing audio feedback for a first item category and train a second generative AI model on flagged item listing audio feedback for a second item category. In some examples, the generative AI model with the appropriate category of the item listing being critiqued is selected for generating the critique.

In some examples, the fine-tuning component 306 is further capable of, configured to, or operable to train a first generative AI model on flagged audio data and train a second generative AI model on one of flagged text data, flagged emotion data, flagged video data, etc. In some examples, one or more generative AI models are used to generate the critique for the item listing. For example, the first generative AI model is used to critique the audio data of the item listing, and the second generative AI model is used to critique the text data of the item listing.

The modification component 310 is further capable of, configured to, or operable to support a means for displaying the modification to the item listing via a graphical user interface. The modification component 310 is further capable of, configured to, or operable to support a means for traversing a knowledge graph to obtain information associated with the prompt.

### Example Procedure

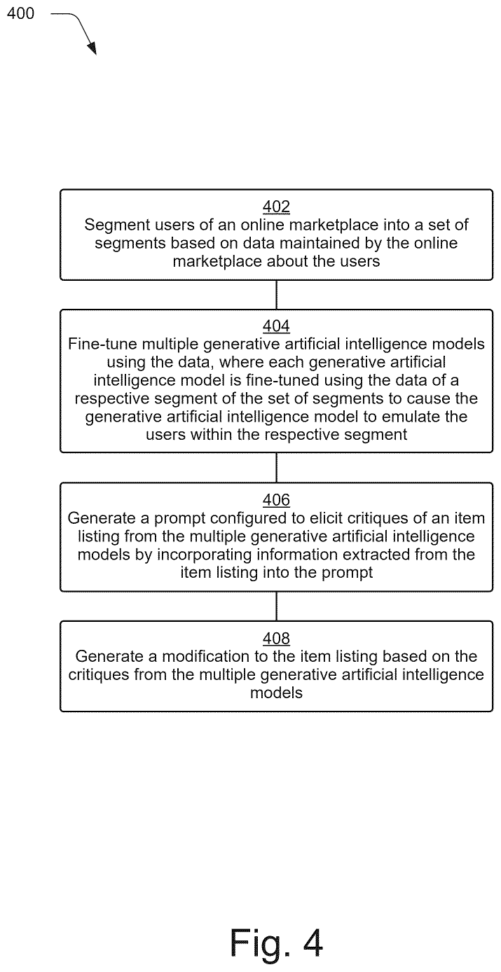

FIG. 4 illustrates an example of a procedure 400 that supports critiquing item listings using buyer perspectives generated by AI leveraging knowledge graphs as described herein. The operations of the procedure 400 are implemented by the listing critique tool 116 as described herein. It should be noted that the procedure 400 described herein describes a possible implementation, and that the operations and the steps are be rearranged or otherwise modified and that other implementations are possible.

At (block 402), users of an online marketplace are segmented into a set of segments based on data maintained by the online marketplace about the user. By way of example, a segmentation component segments users of an online marketplace into a set of segments based on data maintained by the online marketplace about the users, e.g., the listing critique tool 116 or the segmentation component 304.

In some implementations, the data maintained by the online marketplace includes one or more of user feedback on one or more additional item listings, a buying history of the users, an age of the users, an economic status of the users, a gender of the users, or an education of the users.

At (block 404), multiple generative AI models are fine-tuned using the data. By way of example, a fine-tuning component fine-tunes multiple generative AI models using the data, e.g., the listing critique tool 116 or the fine-tuning component 306. In some implementations, each generative AI model is fine-tuned using the data of a respective segment of the set of segments to cause the generative AI model to emulate the users within the respective segment.

In some implementations, audio data, associated with a particular item listing, is received from each of the users. The audio data includes a first set of audio data for a first user and a second set of audio data for a second user. In some implementations, the first set of audio data is analyzed and a first portion of the first set of audio data that is irrelevant to the particular item listing is flagged. In some implementations, the second set of audio data is analyzed and a second portion of the second set of audio data that is irrelevant to the particular item listing is flagged. In some implementations, the multiple generative AI models are fine-tuned based on analyzing the first portion of the first set of audio data flagged and the second portion of the second set of audio data flagged.

In some implementations, video data, associated with a particular item listing, is received from each of the users. The video data includes a first set of video data for a first user and a second set of video data for a second user. In some implementations, a first emotion expressed within the first set of video data is determined. In some implementation, a second emotion expressed within the second set of video data is determined. In some implementations, the multiple generative AI models are fine-tuned based on determining the first emotion and the second emotion. In some implementations, a first generative AI model of the multiple generative AI models is fine-tuned using the first emotion and the second emotion, and a second generative AI model of the multiple generative AI models is fine-tuned using the first portion of the first set of audio data flagged and the second portion of the second set of audio data flagged.

At (block 406), a prompt configured to elicit critiques of an item listing from the multiple fine-tuned generative AI models is generated by incorporating information extracted from the item listing into the prompt. By way of example, a prompt component generates a prompt configured to elicit critiques of an item listing from the multiple fine-tuned generative AI models by incorporating information extracted from the item listing into the prompt, e.g., the listing critique tool 116 or the prompt component 308.

In some implementations, user input requesting feedback about the item listing from a perspective of users within at least one segment of the set of segments is received. In some examples, the information extracted from the item listing includes an image of an item, a video of the item, audio of the item, a title of the item listing, a description of the item listing, or another text attribute of the item listing.

At (block 408), a modification to the item listing is generated based on the critiques from the multiple fine-tuned generative AI models. By way of example, a modification component generates a modification to the item listing based on the critiques from the multiple fine-tuned generative AI models, e.g., the listing critique tool 116 or the modification component 310.

In some implementations, multiple modifications to the item listing are generated based on the user input and each modification corresponds to a respective at least one segment. In some implementations, the modification to the item listing is displayed via a GUI. In some implementations, the modification to the item listing includes a modification to a title of the item listing, a condition of an item associated with the item listing, a description of the item listing, or a combination thereof.

### Example System

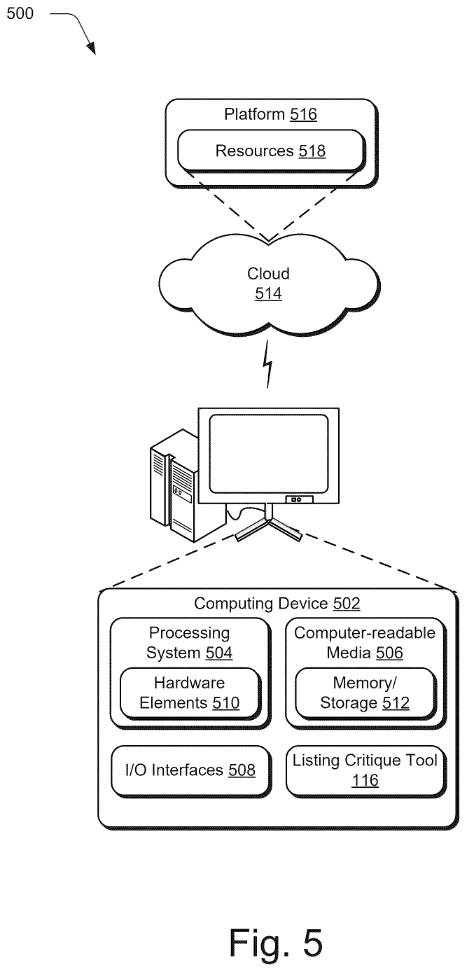

FIG. 5 illustrates an example of system 500 that supports critiquing item listings using buyer perspectives generated by AI leveraging knowledge graphs as described herein. The system 500 includes a computing device 502 that is representative of one or more computing systems and/or devices that implement the various techniques described herein. This is illustrated through inclusion of the listing critique tool 116. The computing device 502 is, for instance, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O interfaces 508 that are communicatively coupled, one to another. Although not shown, the computing device 502 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that are configured as processors, functional blocks, and so forth. This includes implementation in hardware as an application specific integrated circuit or other logic device formed using one or more semiconductors. The hardware elements 510 are not limited by the materials from which the hardware elements 510 are formed or the processing mechanisms employed therein. For instance, processors include semiconductor(s) and/or transistors, e.g., electronic integrated circuits (ICs). In such a context, processor-executable instructions are electronically-executable instructions.

The computer-readable media 506 is illustrated as including memory/storage 512. The memory/storage 512 represents memory/storage capacity associated with one or more computer-readable media. The memory/storage 512 includes volatile media, such as random-access memory (RAM), and/or nonvolatile media, such as read only memory (ROM), Flash memory, optical disks, magnetic disks, and so forth. The memory/storage 512 includes fixed media (e.g., RAM, ROM, a fixed hard drive, and so on) as well as removable media, e.g., Flash memory, a removable hard drive, an optical disc, and so forth. The computer-readable media 506 is configured in a variety of other ways as further described below.

Input/output interface(s) 508 are representative of functionality to allow a user to enter commands and information to computing device 502 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which is employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 is configured in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implemented on a variety of commercial computing platforms having a variety of processors.

An implementation of the described modules and techniques are stored on or transmitted across some form of computer-readable media. The computer-readable media includes a variety of media that is accessed by the computing device 502. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessed by a computer.

“Computer-readable signal media” refers to a signal-bearing medium that is configured to transmit instructions to the hardware of the computing device 502, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that are employed in some implementations to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 510. The computing device 502 is configured to implement particular instructions and/or functions corresponding to the software and/or hardware modules. Accordingly, implementation of a module that is executable by the computing device 502 as software is achieved at least partially in hardware, e.g., through use of computer-readable storage media and/or hardware elements 510 of the processing system 504. The instructions and/or functions are executable/operable by one or more articles of manufacture (For instance, one or more computing devices 502 and/or processing systems 504) to implement techniques, modules, and examples described herein.

The techniques described herein are supported by various configurations of the computing device 502 and are not limited to the specific examples of the techniques described herein. This functionality is also implemented all or in part through use of a distributed system, such as over a “cloud” 514 via a platform 516 as described below.

The cloud 514 includes and/or is representative of a platform 516 for resources 518. The platform 516 abstracts underlying functionality of hardware (e.g., servers) and software resources of the cloud 514. The resources 518 include applications and/or data that are utilized while computer processing is executed on servers that are remote from the computing device 502. Resources 518 also include services provided over the Internet and/or through a subscriber network, such as a cellular or Wi-Fi network.

The platform 516 abstracts resources and functions to connect the computing device 502 with other computing devices. The platform 516 also serves to abstract scaling of resources to provide a corresponding level of scale to encountered demand for the resources 518 that are implemented via the platform 516. Accordingly, in an interconnected device implementation, implementation of functionality described herein is distributed throughout the system 500. For instance, the functionality is implemented in part on the computing device 502 as well as via the platform 516 that abstracts the functionality of the cloud 514.

In some aspects, the techniques described herein relate to a method, including: segmenting users of an online marketplace into a set of segments based on data maintained by the online marketplace about the users; fine-tuning multiple generative AI models using the data, where each generative AI model is fine-tuned using the data of a respective segment of the set of segments to cause the generative AI model to emulate the users within the respective segment; generating a prompt configured to elicit critiques of an item listing from the multiple fine-tuned generative AI models by incorporating information extracted from the item listing into the prompt; and generating a modification to the item listing based on the critiques from the multiple fine-tuned generative AI models.

In some aspects, the techniques described herein relate to a method further including: receiving user input requesting feedback about the item listing from a perspective of users within at least one segment of the set of segments.

In some aspects, the techniques described herein relate to a method further including: generating multiple modifications to the item listing based on the user input, each modification corresponding to a respective at least one segment.

In some aspects, the techniques described herein relate to a method further including: receiving audio data, associated with a particular item listing, from each of the users, the audio data including a first set of audio data for a first user and a second set of audio data for a second user; analyzing the first set of audio data and flagging a first portion of the first set of audio data that is irrelevant to the particular item listing; analyzing the second set of audio data and flagging a second portion of the second set of audio data that is irrelevant to the particular item listing; and fine-tuning the multiple generative AI models based on analyzing the first portion of the first set of audio data flagged and the second portion of the second set of audio data flagged.

In some aspects, the techniques described herein relate to a method further including: receiving video data, associated with a particular item listing, from each of the users, the video data including a first set of video data for the first user and a second set of video data for the second user; determining a first emotion expressed within the first set of video data; determining a second emotion expressed within the second set of video data; and fine-tuning the multiple generative AI models based on determining the first emotion and the second emotion.

In some aspects, the techniques described herein relate to a method further including: displaying the modification to the item listing via a graphical user interface. In some aspects, the techniques described herein relate to a method further including: In some aspects, the techniques described herein relate to a method further including: traversing a knowledge graph to obtain information associated with the prompt, where generating the modification to the item listing is based on the information.

In some aspects, the techniques described herein relate to a system including: one or more processors, and memory storing instructions that, when executed by the one or more processors, cause the system to perform operations including: segmenting users of an online marketplace into a set of segments based on data maintained by the online marketplace about the users; fine-tuning multiple generative AI models using the data, where each generative AI model is fine-tuned using the data of a respective segment of the set of segments to cause the generative AI model to emulate the users within the respective segment; generating a prompt configured to elicit critiques of an item listing from the multiple fine-tuned generative AI models by incorporating information extracted from the item listing into the prompt; and generating a modification to the item listing based on the critiques from the multiple fine-tuned generative AI models.

In some aspects, the techniques described herein relate to a system, the operations further including: receiving user input requesting feedback about the item listing from a perspective of users within at least one segment of the set of segments.

In some aspects, the techniques described herein relate to a system, the operations further including: generating multiple modifications to the item listing based on the user input, each modification corresponding to a respective at least one segment.

In some aspects, the techniques described herein relate to a system, the operations further including: receiving audio data, associated with a particular item listing, from each of the users, the audio data including a first set of audio data for a first user and a second set of audio data for a second user; analyzing the first set of audio data and flagging a first portion of the first set of audio data that is irrelevant to the particular item listing; analyzing the second set of audio data and flagging a second portion of the second set of audio data that is irrelevant to the particular item listing; and fine-tuning the multiple generative AI models based on analyzing the first portion of the first set of audio data flagged and the second portion of the second set of audio data flagged.

In some aspects, the techniques described herein relate to a system, the operations further including: receiving video data, associated with a particular item listing, from each of the users, the video data including a first set of video data for the first user and a second set of video data for the second user; determining a first emotion expressed within the first set of video data; determining a second emotion expressed within the second set of video data; and fine-tuning the multiple generative AI models based on determining the first emotion and the second emotion.

In some aspects, the techniques described herein relate to a non-transitory computer-readable storage medium storing instructions that, when executed by one or more processors, cause the one or more processors to perform operations including: segmenting users of an online marketplace into a set of segments based on data maintained by the online marketplace about the users; fine-tuning multiple generative AI models using the data, where each generative AI model is fine-tuned using the data of a respective segment of the set of segments to cause the generative AI model to emulate the users within the respective segment; generating a prompt configured to elicit critiques of an item listing from the multiple fine-tuned generative AI models by incorporating information extracted from the item listing into the prompt; and generating a modification to the item listing based on the critiques from the multiple fine-tuned generative AI models.

In some aspects, the techniques described herein relate to a non-transitory computer-readable storage medium, the operations further including: receiving user input requesting feedback about the item listing from a perspective of users within at least one segment of the set of segments.

In some aspects, the techniques described herein relate to a non-transitory computer-readable storage medium, the operations further including: generating multiple modifications to the item listing based on the user input, each modification corresponding to a respective at least one segment.

In some aspects, the techniques described herein relate to a non-transitory computer-readable storage medium, the operations further including: receiving audio data, associated with a particular item listing, from each of the users, the audio data including a first set of audio data for a first user and a second set of audio data for a second user; analyzing the first set of audio data and flagging a first portion of the first set of audio data that is irrelevant to the particular item listing; analyzing the second set of audio data and flagging a second portion of the second set of audio data that is irrelevant to the particular item listing; and fine-tuning the multiple generative AI models based on analyzing the first portion of the first set of audio data flagged and the second portion of the second set of audio data flagged.

In some aspects, the techniques described herein relate to a non-transitory computer-readable storage medium, the operations further including: receiving video data, associated with a particular item listing, from each of the users, the video data including a first set of video data for the first user and a second set of video data for the second user; determining a first emotion expressed within the first set of video data; determining a second emotion expressed within the second set of video data; and fine-tuning the multiple generative AI models based on determining the first emotion and the second emotion.

What is claimed is:

1. A method comprising:
segmenting users of an online marketplace into a set of segments based on data maintained by the online marketplace about the users;
fine-tuning multiple generative artificial intelligence models using the data, wherein each generative artificial intelligence model is fine-tuned using the data of a respective segment of the set of segments to cause the generative artificial intelligence model to emulate the users within the respective segment;
generating a prompt configured to elicit critiques of an item listing from the multiple fine-tuned generative artificial intelligence models by incorporating information extracted from the item listing into the prompt; and
generating a modification to the item listing based on the critiques from the multiple fine-tuned generative artificial intelligence models.

2. The method of claim 1, further comprising:
receiving user input requesting feedback about the item listing from a perspective of users within at least one segment of the set of segments.

3. The method of claim 2, further comprising:
generating multiple modifications to the item listing based on the user input, each modification corresponding to a respective at least one segment.

4. The method of claim 1, further comprising:
receiving audio data, associated with a particular item listing, from each of the users, the audio data including a first set of audio data for a first user and a second set of audio data for a second user;
analyzing the first set of audio data and flagging a first portion of the first set of audio data that is irrelevant to the particular item listing;
analyzing the second set of audio data and flagging a second portion of the second set of audio data that is irrelevant to the particular item listing; and
fine-tuning the multiple generative artificial intelligence models based on analyzing the first portion of the first set of audio data flagged and the second portion of the second set of audio data flagged.

5. The method of claim 4, further comprising:
receiving video data, associated with a particular item listing, from each of the users, the video data including a first set of video data for the first user and a second set of video data for the second user;
determining a first emotion expressed within the first set of video data;
determining a second emotion expressed within the second set of video data; and
fine-tuning the multiple generative artificial intelligence models based on determining the first emotion and the second emotion.

6. The method of claim 5, wherein a first generative artificial intelligence model of the multiple generative artificial intelligence models is fine-tuned using the first emotion and the second emotion, and wherein a second generative artificial intelligence model of the multiple generative artificial intelligence models is fine-tuned using the first portion of the first set of audio data flagged and the second portion of the second set of audio data flagged.

7. The method of claim 1, further comprising:
displaying the modification to the item listing via a graphical user interface.

8. The method of claim 1, wherein the data maintained by the online marketplace includes one or more of user feedback on one or more additional item listings, a buying history of the users, an age of the users, an economic status of the users, a gender of the users, or an education of the users.

9. The method of claim 1, wherein the information extracted from the item listing includes an image of an item, a video of the item, audio of the item, a title of the item listing, a description of the item listing, or another text attribute of the item listing.

10. The method of claim 1, wherein the modification to the item listing includes a modification to a title of the item listing, a condition of an item associated with the item listing, a description of the item listing, or a combination thereof.

11. The method of claim 1, further comprising:
traversing a knowledge graph to obtain information associated with the prompt, wherein generating the modification to the item listing is based at least in part on the information.

12. A system, comprising:
one or more processors; and
memory storing instructions that, when executed by the one or more processors, cause the system to perform operations comprising:
segmenting users of an online marketplace into a set of segments based on data maintained by the online marketplace about the users;
fine-tuning multiple generative artificial intelligence models using the data, wherein each generative artificial intelligence model is fine-tuned using the data of a respective segment of the set of segments to cause the generative artificial intelligence model to emulate the users within the respective segment;
generating a prompt configured to elicit critiques of an item listing from the multiple fine-tuned generative artificial intelligence models by incorporating information extracted from the item listing into the prompt; and
generating a modification to the item listing based on the critiques from the multiple fine-tuned generative artificial intelligence models.

13. The system of claim 12, the operations further comprising:
receiving user input requesting feedback about the item listing from a perspective of users within at least one segment of the set of segments.

14. The system of claim 13, the operations further comprising:
generating multiple modifications to the item listing based on the user input, each modification corresponding to a respective at least one segment.

15. The system of claim 12, the operations further comprising:
receiving audio data, associated with a particular item listing, from each of the users, the audio data including a first set of audio data for a first user and a second set of audio data for a second user;
analyzing the first set of audio data and flagging a first portion of the first set of audio data that is irrelevant to the particular item listing;
analyzing the second set of audio data and flagging a second portion of the second set of audio data that is irrelevant to the particular item listing; and
fine-tuning the multiple generative artificial intelligence models based on analyzing the first portion of the first set of audio data flagged and the second portion of the second set of audio data flagged.

16. The system of claim 15, the operations further comprising:
receiving video data, associated with a particular item listing, from each of the users, the video data including a first set of video data for the first user and a second set of video data for the second user;
determining a first emotion expressed within the first set of video data;
determining a second emotion expressed within the second set of video data; and
fine-tuning the multiple generative artificial intelligence models based on determining the first emotion and the second emotion.

17. A non-transitory computer-readable storage medium storing instructions that, when executed by one or more processors, cause the one or more processors to perform operations comprising:
segmenting users of an online marketplace into a set of segments based on data maintained by the online marketplace about the users;
fine-tuning multiple generative artificial intelligence models using the data, wherein each generative artificial intelligence model is fine-tuned using the data of a respective segment of the set of segments to cause the generative artificial intelligence model to emulate the users within the respective segment;
generating a prompt configured to elicit critiques of an item listing from the multiple fine-tuned generative artificial intelligence models by incorporating information extracted from the item listing into the prompt; and
generating a modification to the item listing based on the critiques from the multiple fine-tuned generative artificial intelligence models.

18. The non-transitory computer-readable storage medium of claim 17, the operations further comprising:
receiving user input requesting feedback about the item listing from a perspective of users within at least one segment of the set of segments.

19. The non-transitory computer-readable storage medium of claim 18, the operations further comprising:
generating multiple modifications to the item listing based on the user input, each modification corresponding to a respective at least one segment.

20. The non-transitory computer-readable storage medium of claim 17, the operations further comprising:
receiving audio data, associated with a particular item listing, from each of the users, the audio data including a first set of audio data for a first user and a second set of audio data for a second user;
analyzing the first set of audio data and flagging a first portion of the first set of audio data that is irrelevant to the particular item listing;
analyzing the second set of audio data and flagging a second portion of the second set of audio data that is irrelevant to the particular item listing; and
fine-tuning the multiple generative artificial intelligence models based on analyzing the first portion of the first set of audio data flagged and the second portion of the second set of audio data flagged.
